(19) United States
(12) Patent Application Publication
(10) Pub. No.: US 2009/0221166 A1
(43) Pub. Date: Sep. 3, 2009

(54) ELECTRICAL DEVICE WITH AN I/O WIRING INTERFACE

(75) Inventors: Ofer Berdah, Ashdod (IL); Oren Azoulay, Ramat-Gan (IL); Haim Slotin, Oranit (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/278,205

(22) PCT Filed: Feb. 6, 2007
(86) PCT No.: PCT/US07/61668

§ 371 Date: Jan. 15, 2009

(30) Foreign Application Priority Data
Feb. 7, 2006 (GB) 0602404.6

(51) Int. Cl. H01R 13/64

(52) U.S. Cl. 439/133

(57) ABSTRACT

An I/O wiring interface (100) provides an electrical and mechanical connection for a plurality of wires (210) terminating in the I/O wiring interface (100). The I/O wiring interface (100) comprises a mechanical housing (130) into which one or more terminal block connectors (120) is/are removably locatable and that the I/O wiring interface (100) comprises a mechanically coding mechanism.

### FIELD OF THE INVENTION

Embodiments of the present invention relate to an electrical device and an I/O wiring interface therefor.

### BACKGROUND OF THE INVENTION

A number of electronic control systems must interact with their environment in order to perform the tasks for which they were designed. Devices that control some real aspect of their environment require signals from the environment. Similarly, electrically operated devices require, in the main, electrical signals.

These signals, typically in the form of voltages or currents, travel along, or are measured via, signal-wires, which must be physically connected to the electrical device that requires the information. For example, in an air-conditioner example, a temperature sensor must be wired to a control unit of the device.

There are a number of known methods of connecting wires to an electrical device. For example, it is possible to:
1. hard-wire (solder) them directly to a circuit board of the device;
2. hard-wire them to the device by means of a “screw” or “spring-clamp” type connector located on a terminal-block fixed to a circuit board of the device;
3. Hard-wire them first into a terminal-block, via a screw or spring-clamp mechanism, which then mates with a corresponding socket mounted on the electrical device.

Of these methods, the first is applicable to systems where it is not expected that the input-output (I/O) wiring to/from the device will need to be changed, i.e. added to, replaced, or updated, or where absolute minimum cost is the overriding factor. This construction is extremely inflexible and difficult to modify.

The second solution provides a modicum of flexibility, but is very time consuming if, for example, the circuit board of the device to which the wires are attached needs to be replaced. In this instance, each individual wire must be released from its holding mechanism.

Furthermore, if access to the circuit board is restricted, then physically connecting the wires to the circuit board is very difficult.

The third solution is the most commonly used, with sockets being mounted to a circuit board and corresponding terminal block connectors, with the signal wires terminating in them, being plugged into the sockets.

Some other products available on the market, aimed mainly at industrial and building automation, provide external self-contained, stand alone I/O units to which signal wires are connected. The I/O data is then transferred to a control unit that requires the data, via, say, a serial data bus. The actual interfacing of the wiring to the I/O point is usually achieved via the third method described above.

A significant problem with each of the above constructions lies in their complexity. Often, in a system with a large number of I/O's (for example, machine control systems and general test-equipment may easily have thousands of I/O points), it is necessary to use a variety of connectors. Each connector must be wired correctly and then inserted into a corresponding socket on a circuit board. However, with many circuit boards and many plugs, it is very easy to connect the wrong plug and socket. Furthermore, each individual terminal block connector must be inserted into its socket for use, and removed again for maintenance or modification of the wiring or circuit board, which is very time consuming.

Thus, a need exists for an I/O wiring interface that can simplify the process of connecting signal wires to a control or measurement device or other electrical device, whilst alleviating the problems associated with existing solutions.

### SUMMARY OF THE INVENTION

In accordance with a first aspect of the present invention, there is provided an I/O wiring interface as claimed in claim 1.

In accordance with a second aspect of the present invention, there is provided an electrical device as claimed in claim 10.

Further aspects and advantageous features of the present invention are as described in the appended claims.

An I/O wiring interface is described for providing an electrical and mechanical connection for a plurality of wires terminating in the I/O wiring interface. The I/O wiring interface comprises a mechanical housing into which one or more terminal connector blocks is/are removably locatable.

The construction of the housing of the I/O wiring interface not only protects the wires, but also allows low-cost standard terminal connector blocks to be easily assembled together within a single physical housing, due to the removable and locatable nature. Thus, a large number of signal wires can be aggregated and terminated within a single interface. Advantageously, the signal wires may be attached to any one or more of a variety of terminal blocks and subsequently very quickly connected or disconnected from any further electrical device.

In a further advantageous aspect of the present invention, the terminal connector blocks may be removed or replaced if a connector becomes damaged or needs replacing for any reason. Thus, there is no need to replace the whole I/O wiring interface simply to repair or replace a small part of the structure.

In order to prevent inadvertent misconnection between the I/O wiring interface and an electrical device, the I/O wiring interface is, advantageously, mechanically coded by means of a user adjustable code key. The provision of a simple low cost mechanical coding device prevents incorrect wiring connections from being made, and thus prevents possible damage to the electrical device to which the I/O wiring interface is connected.

In one embodiment, this advantage is achieved by preventing the interface from being mated with any but a correctly coded electrical device; the electrical device also being provided with a corresponding mechanical code-key. This advantageous mechanism is further enhanced by the provision of a mechanical locking mechanism that locks the code-key mechanism in position.

In a yet further advantageous embodiment of the present invention, the I/O wiring interface is provided with an ejector mechanism to readily separate the I/O wiring interface from the electrical device that it is operably coupled to. For example, in one embodiment, the ejector mechanism comprises two mechanical levers. The use of two levers, which may be located at widely separated points on the interface housing. Such an arrangement significantly simplifies removal of the interface from the electrical device to which it is connected. This advantageous embodiment allows the force generated by the attempt to remove the interface, to be distributed more evenly within the housing and mechanical structure of the I/O wiring interface.

In a yet further advantageous embodiment of the present invention, one or both of the levers is designed such that it may also act as a handle for carrying the interface, thus eliminating the need for a separate handle or carrying mechanism.

The I/O wiring interface described in the embodiments of the present invention advantageously allows the use of multiple terminal blocks. In one embodiment of the present invention, the terminal blocks may be of a recognised standard construction. In one embodiment of the present invention respective terminal blocks of the multiple terminal blocks comprise a differing pitch or configuration. In one embodiment of the present invention respective terminal blocks of the multiple terminal blocks comprise a differing size, i.e. single row/double row, etc. These various terminal blocks may be simultaneously and beneficially located within the housing of the interface.

In a further embodiment of the present invention, there is described an electrical device having an input-output (I/O) Module. The I/O module may be provided with one or more sockets for mating with the one or more terminal blocks of the I/O wiring interface. The I/O module may be provided with a code key mechanism to mate with a corresponding mechanical coding mechanism of the I/O wiring interface.

The I/O module may, advantageously, be designed for use with a specific I/O wiring interface and configuration thereof. In this way, optimal use may be made of the flexibility afforded by the embodiments of the I/O wiring interface previously described.

In this manner, the aforementioned problems associated with I/O wiring for electrical devices are substantially resolved, whilst simultaneously, the problems associated with the prior-art are alleviated.

This has been achieved by the provision of an I/O wiring interface, an I/O module and housing therefor, the I/O wiring interface itself having housing, within which a number of standard terminal block connectors may be located. Incorrect insertion of an I/O wiring interface into an I/O module is prevented by a mechanical code-key arrangement fitted to both the I/O wiring interface and I/O module.

The advantages described are merely exemplary. The aforementioned and other advantages may be realized by the embodiments described herein, and not all advantages need be achieved by all embodiments of the invention.

The teachings of the current invention are applicable to I/O wiring interfaces for control systems, such as machine control systems, or a data acquisition system, or instrumentation system. However, it is envisaged that the inventive concept described herein can be used with any electrical device and in any application where an I/O wiring interface is required.

### BRIEF DESCRIPTION OF THE DRAWINGS

Exemplary embodiments of the present invention will now be described, by way of example only, with reference to the accompanying drawings, in which:

FIG. 1 shows two 3-D views of an I/O wiring interface in accordance with an embodiment of the present invention;

FIG. 2 illustrates an example of an electrical system with an I/O wiring interface according to embodiments of the present invention; and

FIG. 3 shows a 3-D representation of an I/O wiring interface mounted to an I/O module, with a section of the housing and opening therein shown.

### DESCRIPTION OF EMBODIMENTS OF THE INVENTION

Embodiments of the present invention will be described in terms of a data acquisition system; however, it will be appreciated that the inventive concept may be embodied in any electrical or electronic device or system that could benefit from a low cost flexible I/O wiring interface.

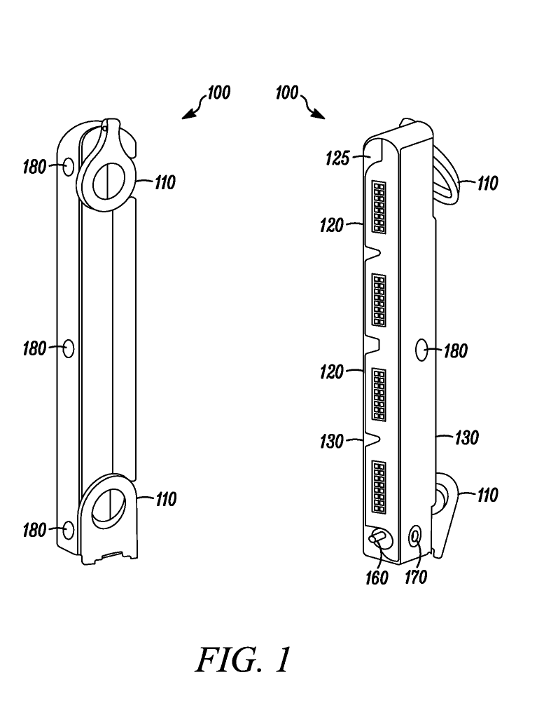

In FIG. 1 there are shown two 3-D views of an I/O wiring interface 100 according to an embodiment of the present invention. One view shows the terminal block connectors 120 with code-key mechanism 160 and associated locking mechanism 170, the second view being of the reverse side showing two levers 110. In both views a number of screws or other suitable fixing means 180 are shown, these being used to hold the two sections of the I/O wiring interface housing together. One or more screws 180 may also be utilised to locate and fix in place the terminal block connectors 120.

For reasons of clarity no wiring is shown connected to the I/O wiring interfaces 100 in FIG. 1. However, the I/O wiring runs from the terminal block connectors 120, where the individual wires are electrically and mechanically terminated, through the body of the interface 100, and out to the outside-world. Individual wires are connected to individual pins of the standard terminal block connectors 120 by whatever means the terminal block connectors 120 provide. The wires may be single core or multi core, shielded or unshielded or of any other type as required by the application.

This high level of flexibility is made possible by the inventive use of standard terminal block connectors 120 mounted within a multi part housing 130, which allows the I/O wiring interface 100 to be modified to accommodate whatever types of wiring are required in the application.

This can be done very quickly, requiring only simple tools and a selection of standard terminal block connectors 120. The user is able to select the correct terminal block connectors 120 for the application, open the housing 130 of the I/O wiring interface 100, by removing screws 180, insert the terminal block connectors 120 within the housing 130, and re-assemble the housing. This process takes only a short time, say of the order of a minute or two, and allows a fully customised I/O wiring interface to be constructed quickly and efficiently.

Although FIG. 1 illustrates terminal blocks of the same size and configuration, it is envisaged that alternative configurations may be used. In this regard, in one embodiment of the present invention, the I/O wiring interface 100 may comprise a range of terminal blocks of the same size, with a plurality of different configurations.

In one embodiment, it is envisaged that terminal blocks of different sizes are supported in the I/O wiring interface 100. In this regard, the I/O wiring interface 100 may comprise a range of terminal blocks of different sizes, with a plurality of different configurations.

In one embodiment, a variation between respective sets of terminal blocks may be supported by use of different facia plates 125. In this embodiment, the different facia plates 125 may contain respective sets of the same sized apertures or respective sets of different sized apertures for receiving corresponding standard terminal blocks.

In one embodiment, such facia plates 125 are pre-configured with standard terminal blocks, and as such may be removed and replaced as a whole unit.

In most cases, the standard terminal blocks may utilise screw-type connectors. However, it is envisaged that more modem types may be used, for example ones that utilise a spring-type pressure contact. These interfaces are well known in the art, and will not be further discussed here. Such terminal blocks are generally similar in that equivalent terminal blocks tend to be approximately the same physical size, but are in general not compatible e.g. they are not interchangeable with each other. Thus a terminal block plug from one company cannot, in general, be used with a terminal block socket from another company.

In one embodiment of the present invention, the I/O wiring interface is thus constructed such that a wide range of such standard terminal block connectors can be incorporated within the housing of the interface, thus further increasing its flexibility and value to the end user. The particular terminal block chosen may depend upon the wiring density required, for example, if a large number of wires must be terminated in one interface, then connectors with multiple rows and very small connector pitch can be used. If, however only a small number of I/O wires are required, then larger pitch connectors may be selected to make fixing the wires (via, say, the spring connections or screw terminals etc) easier.

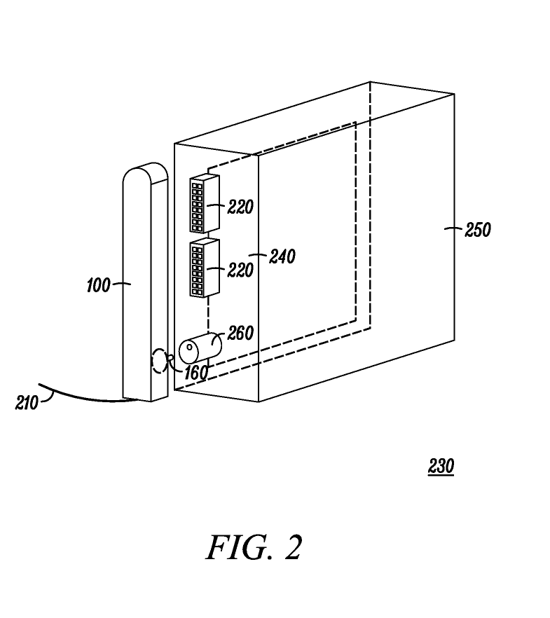

In one embodiment of the present invention, a code-key device 160 is shown in FIG. 1, for example, located on the terminal block connectors 120 at one end of the housing 130 of the interface 100. It is envisaged that this code key may be a simple mechanical key mechanism, designed to mate with a further mechanical code-key mechanism located on an I/O module 240 to which the I/O wiring interface is to be attached, as shown in FIG. 2.

In this embodiment the code-key 160 mounted on the I/O wiring interface 100 may simply be a keyed, rotatable, cylinder, which mates with a suitable mechanical device 260 mounted to the I/O module 240. It is envisaged that the code-key device 160 located on the I/O wiring interface and/or the suitable mechanical device 260 mounted to the I/O module 240 may be adjustable or may be fixed; a fixed arrangement being cheaper to construct.

Only if both code-key mechanism 160 and the suitable mechanical device 260 are correctly aligned will the I/O wiring interface locate to the I/O module. In order to ensure that the adjustable code-key cylinder 160 on the I/O wiring interface does not move, thus changing the coding, a locking mechanism 170 may be provided, which in the embodiment of the example of FIG. 1 is a simple screw-type mechanism. Once the code-key 160 has been set in the desired position, the screw 170 may be tightened and the cylinder locked in position.

In one embodiment, it is envisaged that the locking mechanism 170 may comprise a ‘Go’-‘No Go’ slide. In this embodiment, the locking mechanism 170 serves to provide a further securing option when inserting the terminal block connector in the housing.

In order to further simplify the accurate setting of the code-key, the mechanism may be constructed such that the cylinder has a number of preferred rotational positions into which it “clicks”. It is envisaged that this may be achieved by shaping the surface of the cylinder and the housing in which it turns, to create preferred mechanical positions. Alternatively, it is envisaged that it may be achieved by adding a holding torque by magnetic means.

Assembling or plugging the I/O wiring interface to an I/O module completes the electrical connection between the I/O wiring and an electrical data acquisition (DAQ) system, in the embodiment described, within which the I/O module is located.

A simple schematic of such a DAQ system is illustrated in FIG. 2, whereby the I/O module 240 is shown located within a housing 250. The I/O module is fixed mechanically within the housing 250, within which other components of the DAQ system are also located. These components may be such things as power supplies, communication devices, amplifiers, signal conditioning devices, etc. In FIG. 2, the I/O module 240 may be implemented by means of a simple, standard, printed circuit board (such as a Eurocard format PCB); onto which standard terminal block connector sockets 220 have been mounted. The plugs corresponding to these sockets are located within the housing of the I/O wiring interface 100 (not shown in the schematic view of FIG. 2).

A signal wire “bundle” 210 is shown entering at the bottom of the housing of the interface 100. This bundle of signal wires may, for example, be a multi-core cable, or multiple wires within a sleeve. The wire or bundle of wires run(s) within the housing of the I/O wiring interface 100, which affords the wires mechanical protection. The wire bundle 210 may be further supported by a mechanical strain mechanism located within the housing of the I/O wiring interface 100.

The code-key device 160 is shown oriented such that it matches the “code” set on the I/O module's code-key 260. That is, when pushed together, the code-keys 160, 260 match, thus allowing the I/O wiring interface 100 to brought into physical contact with the I/O module 240.

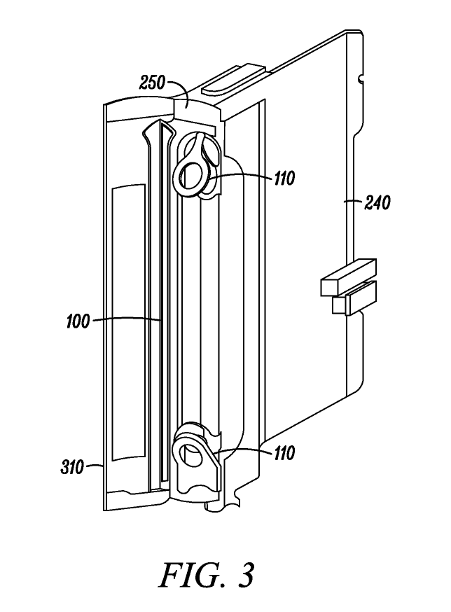

The ejector levers 110, not shown in the schematic of FIG. 2, can be seen in the assembled view of FIG. 3.

In this view, the I/O wiring interface 100 has been plugged into the I/O module by pushing the interface 100 into an opening in the housing 250 that was provided to receive the interface 100. The terminal connector plugs have mated with the corresponding sockets, and the electrical connections have been completed. The I/O wiring interface 100, now electro-mechanically connected to the I/O module, is a form-fit with the housing 250, the body of the I/O wiring interface 100 sitting within an opening in the housing 250.

Despite the form-fit, removal of the I/O wiring interface 100 may simply be a matter of rotating the two levers 110 away from the body of the interface (shown in FIG. 3 partially rotated), thereby allowing the finger-size holes to be grasped and used to pull the interface out of the housing.

The levers 110 may also be linked to a mechanical mechanism, such that rotating a lever forces the I/O module at least partially out of its position within the housing. This makes removal of the I/O wiring interface 100 far less mechanically stressing, by controlling the force applied to both the housing of the interface 100 and the system housing 250. The use of two levers also ensures that the extraction force is evenly distributed throughout the housing of the interface 100, thus helping to prevent damage to the terminal block connectors 120 and sockets 220 by minimising shear forces on the terminal block plugs and sockets, and thus also the I/O module and the housing 250 itself.

In a further advantageous embodiment of the present invention, the I/O module comprises a printed circuit board with edge mounted socket or sockets. A module of this basic type can be easily constructed from readily available low cost materials, and provides, in conjunction with the I/O wiring interface of the present invention, a very flexible I/O solution with, if required, a very high wiring density.

A further benefit of the flexible construction of the I/O wiring interface 100 can be seen in the ease by which a higher IP (Ingress Protection) rating can be achieved if required. In an application where dust or moisture ingress into the housing of the I/O wiring interface may be a problem, the interface may have to have a higher IP rating. In this case, it is possible to disassemble the housing 130 of the interface as previously described, place a sealing mechanism such as a suitably formed silicon gasket within the housing 130, and reassemble.

It is also anticipated that the housing can be constructed from a variety of materials, such as plastics or metals, depending upon the requirements of the application. Furthermore, it is also anticipated that further components could be located within the housing, such as passive or active electrical components such as resistors, capacitors, printed circuit boards (PCBs), integrated circuits (ICs), etc. These components may be used to provide specific signal conditioning such as filtering to improve electrical noise immunity, for example.

LED's or other indicators or displays may also be incorporated within the housing 130 of the I/O wiring interface 100 in order to provide added functionality as required.

Whilst specific embodiments of the present invention have been described, it is clear that one skilled in the art could readily apply further variations and modifications of such embodiments within the scope of the accompanying claims.

It will be appreciated that references to specific functional devices or elements are only to be seen as references to suitable means for providing the described functionality, rather than indicative of a strict logical or physical structure or organization of components.

Aspects of the invention may be implemented in any suitable form. The I/O wiring interface may, for example, incorporate both plug and socket types of standard terminal block. The elements and components of an embodiment of the invention may be physically, functionally and/or logically implemented in any suitable way. Indeed, the functionality of the I/O module may be integrated directly into the housing 250 of the electrical system.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second”, etc. do not preclude a plurality.

Thus, an I/O wiring interface 100 with a multi part housing within which standard terminal block connectors can be located has been described, the housing 130 may also incorporate a code-key mechanism 160 and at least two levers that provide a means for extracting the I/O wiring interface 100 from a further housing 250, incorporating a code-key mechanism 260, of an electrical system in which the interface is located, where the aforementioned disadvantages with prior art arrangements have been substantially alleviated.

1. An input/output (I/O) wiring interface for providing an electrical and mechanical connection for a plurality of wires terminating in the I/O wiring interface, the I/O wiring interface comprising:
a mechanical housing into which one or more terminal block connectors is/are removably locatable; and
a mechanically coding mechanism that comprises an adjustable code key.

2. The I/O wiring interface if claim 1 wherein the adjustable code key contains a mechanical locking mechanism.

3. The I/O wiring interface of claim 1 further comprising an ejector mechanism for ejecting the I/O wiring interface from an electrical or electronic device operably coupled to the I/O wiring interface.

4. The I/O wiring interface of claim 3 wherein the ejector mechanism comprises at least two mechanical levers.

5. The I/O wiring interface of claim 1 wherein the mechanical housing is arranged to accept multiple removably locatable terminal block connectors of different configurations.

6. The I/O wiring interface of claim 1 wherein the mechanical housing is arranged to accept multiple removably locatable terminal block connectors of different sizes.

7. The I/O wiring interface of claim 1 wherein the mechanical housing comprises a facia having one or more apertures for receiving the one or more removably locatable terminal block connectors.

8. An electrical device comprising an input/output (I/O) module arranged to couple to the wired interface according to claim 1.

9. The electrical device of claim 8 wherein the I/O module contains one or more sockets for mating with the one or more terminal block connectors.

10. The electrical device of claim 8 wherein the I/O module contains a code key mechanism for coupling to the mechanically coding mechanism of the I/O wiring interface.
